(19) United States
(12) Patent Application Publication
(10) Pub. No.: US 2004/0142248 A1
(43) Pub. Date: Jul. 22, 2004

(54) Method for preparing holographic stereogram with silver halide photographic sensitized material

(75) Inventor: Noriyuki Kokeguchi, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/751,481

(22) Filed: Jan. 6, 2004

(30) Foreign Application Priority Data
Jan. 9, 2003 (JP) JP2003-003010

(51) Int. Cl. G03H 1/04

(52) U.S. Cl. 430/1; 430/2; 359/3; 430/404; 430/353; 430/350

(57) ABSTRACT

A method for producing a holographic stereogram, comprising the steps of:

(i) computing image information data for producing the holographic stereogram based on a plurality of image data provided by a digital camera;

(ii) recording the image information data on a silver halide photographic material,

(iii) developing the recorded silver halide photographic material at a temperature of between 43 and 180° C.; and

(iv) superimposing the developed silver halide photographic material with a processing member in the presence of an aqueous solvent; and

(v) separating the processing member superimposed on a surface of the developed silver halide photographic material to obtain the holographic stereogram,

wherein the silver halide photographic material comprises a support having thereon:

(a) a hydrophilic colloid layer; and

(b) a silver halide emulsion layer containing silver halide grains having an average particle diameter of 5 to 50 nm.

### TECHNICAL FIELD OF THE INVENTION

The present invention relates to a silver halide photographic sensitized material for holograms, a method for preparation of holograms and a hologram forming system, in which hologram image stability, simplicity and convenience during hologram formation, and environmental conformity are excellent, and consumers can enjoy easy use thereof.

### BACKGROUND OF THE INVENTION

As a display method to watch images stereoscopically, a hologramic method, a lenticular method, and a stereo method are known. Of these, a hologramic method has received highly favorable view due to its overwhelming high image quality and information volume of reproduced images, and further due to the possibility that observers can observe natural stereoscopic imagery without uncomfortable visual manipulation.

A hologramic method is a method which records light waves from an object on a recording material as interference fringes using a reference wave, and then reproduces a wavefront of the object as diffraction light from the hologram. Specifically, a Lippmann type hologram, a rainbow hologram, and holographic stereograms are suitable methods to record object for visual effects as white light reproduction holograms.

As a hologram recording material, known are a silver halide photographic sensitized material, gelatin dichromate and a photopolymer. Drawbacks of gelatin dichromate are that it has low sensitivity resulting in need of a high power laser, and its accompanying liquid processing being undesirable to the environment due to use of ammonium dichromate, and further the recorded images are easily affected by heat. Photopolymers exhibit high definition, but have the drawback of low sensitivity which requires long exposure time. On the other hand, a silver halide photographic sensitized material (hereinafter, referred to simply as a sensitized material) has high sensitivity making it superior in exposure aptitude, and also handling of materials is readily done. However, processing solutions which are undesirable to the environment, are necessary, and further technology improvement is being sought.

As the foregoing silver halide photographic sensitized material, a silver halide photographic sensitized material for holograms is disclosed (for example, see Patent Documents 1 and 2), however, both are a method which requires processing to soak a sensitized material in processing solution baths, resulting in the drawback of environmental suitability.

Further, an enhancing technology of processing convenience of a silver halide photographic sensitized material for holograms is proposed (for example, refer to Patent Document 3), however, even though the disclosed method is convenient and superior in environmental suitability, it is a method to form only amplitude type holograms and exhibits low diffraction efficiency. Further, this method has the drawback of insufficient raw material stability and image stability of the printed images, both of which are thought to be due to the composition of the sensitized material.

On the other hand, a processing method in which a processing member and a sensitized material are overlapped and then subjected to thermal development (for example, refer to Patent Documents 4 and 5), however, in this method, description about a hologram recording silver halide photographic sensitized material is not observed at all.

Further, a method to conduct a perspective exchange image processing, an image processing accumulating output means, and a holographic stereogram printing means using the image rows which are formed by image processing selectively provided for still images (refer to for example, Patent Document 6), however, in this method, description about a system using a silver halide photographic sensitized material for holograms is not observed at all.

Patent Document 1: unexamined Japanese Patent Application Publication 10-123643 (hereinafter, referred to as JP-A).

Patent Document 2: JP-A 10-149084

Patent Document 3: JP-A 2001-305938

Patent Document 4: JP-A 9-325463

Patent Document 5: JP-A 9-146246

Patent Document 6: JP-A 2002-123159

An object of the present invention is to provide a silver halide photographic sensitized material for holograms which is superior in simplicity and convenience and is environmentally suitable during formation of holograms, and exhibits recorded hologram image stability, and also to provide a hologram forming method and a hologram forming system in both of which consumers can enjoy easy and convenient picture taking and image viewing.

### SUMMARY OF THE INVENTION

The above object of the present invention was achieved employing the following embodiments.

(1) A method for producing a holographic stereogram, comprising the steps of:

(i) computing image information data for producing the holographic stereogram based on a plurality of image data provided by a digital camera;

(ii) recording the image information data on a silver halide photographic material,

(iii) developing the recorded silver halide photographic material at a temperature of between 43 and 180° C.; and

(iv) superimposing the developed silver halide photographic material with a processing member in the presence of an aqueous solvent; and

(v) separating the processing member superimposed on a surface of the developed silver halide photographic material to obtain the holographic stereogram,

wherein the silver halide photographic material comprises a support having thereon:

(a) a hydrophilic colloid layer; and

(b) a silver halide emulsion layer containing silver halide grains having an average particle diameter of 5 to 50 nm.

(2) The method for producing the holographic stereogram of Item 1,

wherein the hydrophilic colloid layer of the silver halide photographic material further contains an insoluble metal oxide or an insoluble metal hydroxide.

(3) The method for producing the holographic stereogram of Item 1,

wherein the silver halide emulsion layer of the silver halide photographic material further contains a compound represented by one of Formulas (1) to (6):

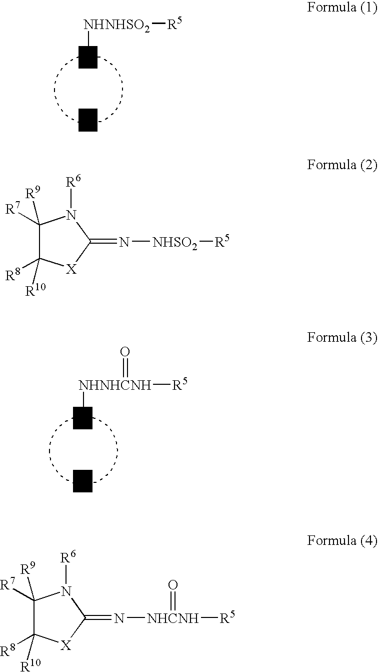

wherein R⁵ is a substituted or unsubstituted alkyl, aryl or heterocyclic group; Z indicates a group of atoms forming an aromatic ring, provided that when Z forms a benzene ring with a carbon atom, the benzene ring have one or a plurality of substituents having a sum of Hammett's constant σp of the substituents is more than 1; R⁶ is a substituted or unsubstituted alkyl group; X is an oxygen atom, a sulfur atom, a selenium atom or a tertiary amino group having an alkyl or aryl group; and R⁷-R¹⁰ each are a hydrogen atom or a substituent, and R⁷-R¹⁰ each may combine with each other to form a double bond or a ring:

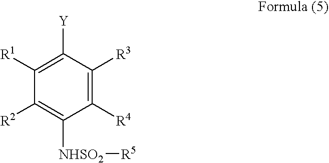

wherein Y is a hydroxyl group or a substituted or unsubstituted amino group; R¹-R⁴ each are a hydrogen atom, a halogen atom, an alkyl group, an aryl group, an alkylcarbonamide group, an arylcarbonamide group, an alkylsulfonamide group, an arylsulfonamide group, an alkoxyl group, an aryloxy group, an alkylthio group, an arylthio group, an alkylcarbamoyl group, an arylcarbamoyl group, a carbamoyl group, an alkylsulfamoyl group, an arylsulfamoyl group, a sulfamoyl group, a cyano group, an alkylsulfonyl group, an arylsulfonyl group, an alkoxycarbonyl group, an aryloxycarbonyl group, an alkylcarbonyl group, an arylcarbonyl group, or an acyoxy group; and R⁵ is the same as R⁵ in Formulas (1)-(4):

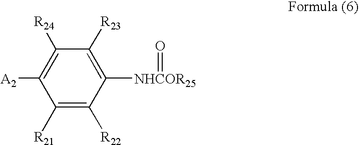

wherein R₂₁-R₂₅ each are a hydrogen atom or a substituent; A₂ is a hydroxyl group or a substituted amino group; R₂₁ and R₂₂, and R₂₃ and R₂₄, may combine with each other to form a ring; and the substituted amino group of A₂ and R₂₁ or R₂₄ may combine with each other to form a ring.

(4) The method for producing the holographic stereogram of Item 1,

wherein the processing member containing a silver bleaching agent and a silver halide fixing agent; and an amount of the aqueous solvent used in the step (iv) is between 1/10 and 1/100 of a volume required to maximally swell the silver halide emulsion layer and the hydrophilic colloid layer on the support.

(5) The method for producing the holographic stereogram of Item 1,

wherein the processing member containing a silver bleaching agent; and an amount of the aqueous solvent used in the step (iv) is between 1/10 and 1/100 of a volume required to maximally swell the silver halide emulsion layer and the hydrophilic colloid layer on the support.

(6) The method for producing a holographic stereogram of Item 1,

wherein the processing member containing a silver halide fixing agent; and an amount of the aqueous solvent used in the step (iv) is between 1/10 and 1/100 of a volume required to maximally swell the silver halide emulsion layer and the hydrophilic colloid layer on the support.

(7) The method for producing the holographic stereogram of Item 1,

wherein the hydrophilic colloid layer of the silver halide photographic material further contains an insoluble metal oxide or an insoluble metal hydroxide; the processing member contains a physical developing nucleus, a complex forming agent and a silver fixing agent; and an amount of the aqueous solvent used in the step (iv) is between 1/10 and 1/100 of a volume required to maximally swell the silver halide emulsion layer and the hydrophilic colloid layer on the support.

(8) The method for producing the holographic stereogram of Item 1, further comprising the step of:

subjecting the exposed silver halide photographic material to an activator processing prior to the step (iii).

### BRIEF DESCRIPTION OF DRAWINGS

FIG. 1: A flow diagram to show an example of a processing flow of a hologram forming system of the present invention.

FIG. 2: A flow diagram to show another example of a processing flow of a hologram forming system of the present invention.

### DESCRIPTION OF THE PREFERRED EMBODIMENTS

The details of a silver halide photographic sensitized material for holograms recording, a hologram forming method, and a hologram forming system of the present invention will be described below.

A silver halide photographic sensitized material for holograms in the present invention has a hydrophilic colloidal layer containing at least one silver halide emulsion layer on a substrate, and the average particle size of silver halide particles in the silver halide emulsion layer is not less than 5 nm and not more than 50 nm, and also contains a insoluble metal oxide or a insoluble metal hydroxide.

A silver halide photographic sensitized material of the present invention is a transparent type, and resolution power of the sensitized material is the higher, the more preferable reproduction images are obtained.

In general, resolution power of a sensitized material is subjected to the sizes of the silver halide particles. The average particle size of the silver halide particles used in the sensitized material of the present invention is 5-50 nm, however the specifically preferable average particle size is 10-40 nm. The smaller the average particle size is, the more preferable it is, because development processing time can be shortened, higher resolution power can be obtained, and images without delustering can be produced. However, use of silver halide particle having excessively small particle size is not desirable because of it tends to result in drawbacks of lowered sensitivity, staining of images or processing solutions, or deterioration of storage stability of the sensitized material.

The term “average particle size” in the present invention is commonly used in the field and is an easily understood expression. In cases when particles are spherical or approximate a sphere, the particle size means particle diameter. Further, in cases when the particles are cubic, the particles are considered to be spheres and the diameters are referred to as the particle size. For details of determination of the average particle size please refer to The Theory of the Photographic Process, ₃rd edition, by C. E. K. Mees & T. H. James, pgs. 36-43 (1966, published by The Macmillan Company, N.Y.).

The silver halide particles of the present invention may be in a so-called Lippmann emulsion having an average particle size of less than 0.05 μm. As a Lippmann emulsion, usable are silver halide emulsions described in British Patent No. 1,139,062, U.S. Pat. No. 3,573,057, and examined Japanese Patent Publication 49-8333. Specifically preferable silver halide emulsions include silver halide emulsions described in JP-A Nos. 58-160948 and 60-12540.

Silver halide compositions of a silver halide emulsion used in a silver halide photographic sensitized material for holograms of the present invention may be any of silver chloride, silver iodide, silver bromide, silver iodobromide, and silver chloroiodobromide. Preferable is a silver iodobromide emulsion having a silver iodide content of less than 5.0 mol %.

As a preparation method of ultra fine silver halide particles having the average particle size defined in the present invention is not specifically limited, but preferred are preparation methods of mixing a silver nitrate aqueous solution and a water soluble halide compound aqueous solution via a single-jet method, a double-jet method, or a controlled double-jet method.

In the present invention, silver halide particles may be formed by growth of prepared silver halide particles (nuclear particles), or by continuous nuclear development growth. Further, as a prior method to further minimize the particle size, preferred methods include a method to conduct the foregoing mixing operation in the presence of a silver halide insolubilizing agent such as azaindenes, mercapto compounds, benzotriazoles, benzimidazoles, indazoles and phthalazines; a method in which a silver nitrate aqueous solution and a water soluble halide compound aqueous solution are inline-mixed, and then followed continuously by further inline-mixing of an insolubilizing agent and a water miscible organic solvent solution; and a method in which both of the foregoing aqueous solutions are added into a water miscible organic solvent solution.

The shape of silver halide particles used in the present invention is not limited, and used can be any such as tabular, spherical, cubic, tetradecahedral, regular octahedral, and others, however of these, cubic particles are preferable.

Further, during the formation and/or growth process of particles, metallic ions are added using at least a cadmium salt, a zinc salt, a lead salt, a thallium salt, an iridium salt (including its complex salts), a rhodium salt (including its complex salts), and an iron salt (including its complex salts), whereby metal atoms may be contained in the interior of the particle and/or on the surface of the particle.

Of the foregoing metallic ions, considering emhanced effects of high-intensity reciprocity law failure properties, a metallic salt of iridium exhibits the most preferable result. Further, a metallic salt preferably has a complex structure coordinated to fill the “d” orbital. As a ligand, preferable are a halogen, a cyano, or a nitrosyl group, or H₂O. Specifically preferable is a transition metal complex having a ligand selected from a halogen ion, H₂O, a nitrosyl group, a thionitrosyl group, or a cyan ion.

A silver halide emulsion used in the present invention may eliminate unnecessary water soluble salts during growth of silver halide particles, or may containe the salts. In cases to eliminate the salts, a usable method is described in Research Disclosure (hereinafter, referred to as R. D.), No. 17643, sec. II. Further, the salts may also be eliminated using a noodle washing method or an ultrafiltration method.

In the present invention, the silver halide emulsion is preferably subjected to chemical sensitization. As chemical sensitization methods, preferably employed are gold sensitization, noble metal sensitization using a metal of the VIII Group in the periodic table such as Pd and Pt, sulfur sensitization, reduction sensitization, sensitization using a chalcogen compound, and a sensitization method using a combination of these methods. Of these, preferable are the combination of gold sensitization and sulfur sensitization, and gold sensitization and chalcogen compound such as a selenium compound as a combination method.

The added amount of the foregoing selenium compound is determined based on function, but preferably a selenium compound and sodium thiosulfate are used in combination during chemical sensitization, and preferably both of them are used in a ratio of 2:1-1:1.

As selenium compounds, listed are various well known compounds, and examples of usable selenium compounds include, for example, a colloidal selenium metal, isoselenocyanates (such as allylisoselenocyanate), selenoureas (such as N,N-dimethylselenourea, triethylN,N,N′-selenourea, N,N,N′-trimethyl-N′-heptafluoropropylcatbonylselenourea, N,N,N′-trimethyl-N7-4-nitrophenylcarbonylselenourea), selenoketones (such as selenoacetone, selenoacetophenone), selenoamides (such as selenoacetoamide, N,N-dimethylselenobenzamide), selenocarboxylic acids and selenoesters (such as 2-selenopropionic acid, methyl-3-selenobutylate), selenophosphates (such as tri-p-triselenophosphate), selenides (such as triphenylphophineselenide, diethylselenide, diethyldiselenide). Specifically preferable selenium sensitizing agents are selenides, selenoureas, selenoamides and selenoketones.

The used amount of a selenium sensitizing agent varies based on the selenium compound used, silver halide particles, and chemical ripening conditions, but is generally used in the range of about 1×10⁻⁸−1×10⁻⁴ mol per mol of silver halide. The adding method may be a method to add a selenium compound dissolved into water or alone organic solvent or mixed solvents such as methanol and ethanol, based on properties of the selenium compound. Further, a method to add the selenium compound mixed in advance with aqueous gelatin solution, or a method to add the selenium compound in the form of emulsified dispersion in the mixture solution with a polymer soluble in organic solvents as described in JP-A 4-140739, may be selected.

Temperature for chemical ripening using a selen sensitizing agent is preferably in the range of 40-90° C., and more preferably 45-80° C. Further, the pH of the silver halide emulsion is preferably 4-9, and the pAg of that is preferably in the range of 6-9.5.

Further, chemical sensitization is preferably conducted in the presence of a compound exhibiting sorbability for silver halide particles. Examples of such compounds include azoles such as diazoles, triazoles, tetrazoles, indazoles, and thiazoles, and further pyrimidine and azaindens. Specifically preferable are compounds having the above nuclear which is substituted by a mercapto group or an aryl group.

In the silver halide photographic sensitized material for hologramss of the present invention, one of the characteristics is to contain a insoluble metal oxide or a insoluble metal hydroxide.

The term “insoluble” in the present invention means that solubility in 20° C. water (being grams of a solute dissolved in 100 g water) is not more than 0.5, and as the examples of metal oxides or metal hydroxides, metal compounds represented by following Formula (I) are preferably used.

Formula (I)

ZₘXₙ

wherein Z indicates any metal except alkaline metals, X indicates an oxide ion, a hydroxide ion, a carbonate ion, a phosphate ion, a borate ion or an aluminate ion, while m and n each indicate an integer to maintain the balance of atomic valences between Z and X.

A metal compound represented by Formula (I) may contain crystal water, and may form a double salt. As preferable examples of Z, listed are transition metal ions such as Zn²⁺, Co²⁺, Ni²⁺, Fe²⁺, Mn²⁺, Cu²⁺, Hg²⁺, and Zr²⁺; and an alkaline-earth metal ion such as Ba²⁺, Sr²⁺, and Ca²⁺; of which specifically preferable are Zn²⁺, Co²⁺, Ni²⁺, Cu²⁺, and Mn²⁺. Preferable examples of X are an oxide ion and a hydroxide ion.

Exemplary metal compounds being insoluble to water represented by Formula (I) are listed below. Listed of example are Zn(OH)₂, ZnO, Co(OH)₂, CoO, Ni(OH)₂, Cu(OH)₂, Fe(OH)₂, Mn(OH)₂, BaCO₃, SrCO₃, CaCO₃, basic zinc carbonate, basic cobalt carbonate, basic nickel carbonate, and basic bismuth carbonate. Of these compounds, preferred are those in which dispersed solutions are not colored when dispersed in water specifically containing dispersing medium. Specifically preferred are ZnO and Zn(OH)₂.

The preferable added amount of the foregoing insoluble metal compound of the present invention is 1.0-100 mmol per m² of the sensitized material, and the preferable added layers of the sensitized material are layers which do not contain photo-sensitized silver halides.

In the present invention, a characteristic is that a silver halide photographic material for holograms comprises a substrate and a hydrophilic colloidal layer containing at least one silver halide emulsion layer thereon, and the average particle size of silver halide particles in the silver halide emulsion layer is between 5-50 nm, and further contains at least one developing agent selected from compounds represented by foregoing Formulas (1)-(6).

The details of developing agents represented by foregoing Formulas (1)-(6) of the present invention will now be described.

The compounds represented by foregoing Formula (1) are generically named sulfonylhydrazines. Further, the compounds represented by foregoing Formula (3) are generically named carbamoylhydrazines. In the formulas, Z indicates a group of atoms which form an aromatic ring. An aromatic ring formed by Z is required to be sufficiently electron-withdrawing, to give silver-developing activity to the compounds of the present invention. Consequently, preferably used is an aromatic ring to form a nitrogen containing aromatic ring, or in which an electron-withdrawing group is introduced to a benzene ring. As these aromatic rings, preferred are a pyridine ring, a pyradine ring, a pyrimidine ring, a quinoline ring, and a quinoxaline ring. In the case of a benzene ring, as its substituent group, listed are alkylsulfonyl groups (such as a methanesulfonyl group, and an ethanesulfonyl group); halogen atoms (such as a chloro group and a bromo group); alkylcarbamoyl groups (such as a methylcarbamoyl group, a dimethylcarbamoyl group, an ethylcarbamoyl group, a diethylcarbamoyl group, a dibutylcarbamoyl group, a piperidylcarbamoyl group, and a morpholylcarbamoyl group); arylcarbamoyl groups (such as a phenylcarbamoyl group, a methylphenylcarbamoyl group, an ethylphenylcarbamoyl group, and a benzilphenylcarbamoyl group); carbamoyl groups; alkylsulfamoyl groups (such as a methylsulfamoyl group, a dimethylsulfamoyl group, an ethylsulfamoyl group, a diethylsulfamoyl group, a dibutylsulfamoyl group, a piperidylsulfamoyl group, and a morpholylsulfamoyl group); arylsulfamoyl groups (such as a phenylsulfamoyl group, a methylphenylsulfamoyl group, an ethylphenylsulfamoyl group, and a benzilphenylsulfamoyl group); sulphamoyl groups; cyano groups; alkylsulfonyl groups (such as a methanesulfonyl group and an ethanesulfonyl group); arylsulfonyl groups (such as a phenylsulfonyl group, a 4-chlorophenylsulfonyl group, and a p-toluenesulfonyl group); alkoxycarbonyl groups (such as a methoxycarbonyl group, an ethoxycarbonyl group, and a butoxycarbonyl group); aryloxycarbonyl groups (such as a phenoxycarbonyl group); alkylcarbonyl groups (such as an acetyl group, a propionyl group, and a butyroyl group); or arylcarbonyl groups (such as a benzoyl group and an alkylbenzoyl group). The sum of Hammett's constant σp values of the foregoing substituent groups is to be not less than 1.

The compounds represented by foregoing Formula (2) are generically named sulfonylhydrazones. Further, the compounds represented by foregoing Formula (4) are generically named carbamoylhydrazones. R⁶ indicates a substituted or unsubstituted alkyl group (such as a methyl group and an ethyl group). X indicates an oxygen atom, a sulfur atom, a selenium atom or an alkyl substituted or aryl substituted tertiary nitrogen atom, of which an alkyl substituted tertiary nitrogen atom is preferred. R⁷ and R⁸ each indicate a hydrogen atom or a substituent, and R⁷ and R⁸ may form a double bond or a ring in combining with each other.

The compounds represented by foregoing Formula (5) are generically named sulfonamidephenols or sulfonamideanilines. R¹-R⁴ each indicate a hydrogen atom; a halogen atom (such as a chloro group and a bromo group); alkyl groups (such as a methyl group, an ethyl group, an isopropyl group, an n-butyl group, and a t-butyl group); aryl groups (such as a phenyl group, a tolyl group and a xylyl group); alkylcarboamide groups (such as an acetylamino group, a propionylamino group, and a butyloylamino group); arylcarboamide groups (such as a benzoylamino group); alkylsulfonamide group (such as a methanesulfonylamino group, and an ethanesulfonylamino group); arylsulfonamide groups (such as a benzensulfonylamino group, and a toluenesulfonylamino group); alkoxy groups (such as a methoxy group, an ethoxy group, and a butoxy group); aryloxy groups (such as a phenoxy group); alkylthio groups (such as a methylthio group, an ethylthio group, and a butylthio group); arylthio groups (such as a phenylthio group and a tolylthio group); alkylcarbamoyl groups (such as a methylcarbamoyl group, a dimethylcarbamoyl group, an ethylcarbamoyl group, a diethylcarbamoyl group, a dibutylcarbamoyl group, a piperidylcarbamoyl group, and a morpholylcarbamoyl group); arylcarbamoyl groups (such as a phenylcarbamoyl group, a methylphenylcarbamoyl group, an ethylphenylcarbamoyl group, and a benzilphenylcarbamoyl group); carbamoyl groups; alkylsulfamoyl groups (such as a methylsulfamoyl group, a dimethylsulfamoyl group, an ethylsulfamoyl group, a diethylsulfamoyl group, a dibutylsulfamoyl group, a piperidylsulfamoyl group, and a morpholylsulfamoyl group); arylsulfamoyl groups (such as a phenylsulfamoyl group, a methylphenylsulfamoyl group, an ethylphenylsulfamoyl group, and a benzilphenylsulfamoyl group); sulfamoyl groups; cyano groups; alkylsulfonyl groups (such as a methanesulfonyl group and an ethanesulfonyl group); arylsulfonyl groups (such as a phenylsulfonyl group, a 4-chlorophenylsulfonyl group, and a p-toluenesulfonyl group); alkoxycarbonyl groups (such as a methoxycarbonyl group, an ethoxycarbonyl group, and a butoxycarbonyl group); aryloxycarbonyl groups (such as a phenoxycarbonyl group); alkylcarbonyl groups (such as an acetyl group, a propionyl group, and a butyroyl group); arylcarbonyl groups (such as a benzoyl group and an alkylbenzoyl group); or acyloxy groups (such as an acetyloxy group, a propionyloxy group, and a butyloyloxy group). The sum of Hammett's constant σp values of R¹-R⁴ is preferably more than 0.

R⁵ indicates an alkyl group (such as a methyl group, an ethyl group, a butyl group, an octyl group, a lauryl group, a cetyl group, and a stearyl group); an aryl group (such as a phenyl group, a tolyl group, and a xylyl group, a 4-methoxyphenyl group, a dodecylphenyl group, a chlorophenyl group, a trichlorophenyl group, a nitrochlorophenyl group, a triisopropylphenyl group, a 4-dodecyloxyphenyl group, and a 3,5-di-methoxycarbonyl group); or heterocyclic groups (such as a pyridyl group). Y indicates a hydroxyl group or a substituted or unsubstituted amino group.

Examples of the compounds represented by foregoing Formulas (1)-(5) include the compounds, for example, described in JP-A 2001-281824, paragraph Nos. [0042]-[0061].

Next, the compounds represented by foregoing Formula (6) will be described.

In Formula (6), R₂₁-R₂₅ each indicate a hydrogen atom or a substituent group. Examples of the substituent groups represented by R₂₁-R₂₅ include halogen atoms (such as a chloro group and a bromo group); alkyl groups (such as a methyl group, an ethyl group, an isopropyl group, an n-butyl group, and a t-butyl group); aryl groups (such as a phenyl group, a tolyl group and a xylyl group); carbonamide groups (such as an acetylamino group, a propyonylamino group, a butyloylamino group, and a benzoylamino group); sulfonamide groups (such as a methanesulfonylamino group, an ethanesulfonylamino group, a banzenesulfonylamino group, and a toluenesulfonylamino group); alkoxy groups (such as a methoxy group, and an ethoxy group); aryloxy groups (such as a phenoxy group); alkylthio groups (such as a methylthio group, an ethylthio group, and a butylthio group); arylthio groups (such as a phenylthio group and a tolylthio group); carbamoyl groups (such as a methylcarbamoyl group, a dimethylcarbamoyl group, an ethylcarbamoyl group, a diethylcarbamoyl group, a dibutylcarbamoyl group, a piperidynocarbamoyl group, a morpholynocarbamoyl group, a phenylcarbamoyl group, a methylphenylcarbamoyl group, an ethylphenylcarbamoyl group, and a benzilphenylcarbamoyl group); sulfamoyl groups (such as a methyl sulfamoyl group, a dimethylsulfamoyl group, an ethylsulfamoyl group, a diethylsulfamoyl group, a dibutylsulfamoyl group, a piperidynosulfamoyl group, a morpholylsulfamoyl group, a phenylsulfamoyl group, a methylphenylsulfamoyl group, an ethylphenylsulfamoyl group, and a benzilphenylsulfamoyl group); cyano groups; sulfonyl groups (such as a methanesulfonyl group, an ethanesulfonyl group, a phenylsulfonyl group, a 4-chlorophenylsulfonyl group, and a p-toluenesulfonyl group); alkoxycarbonyl groups (such as a methoxycarbonyl group, an ethoxycarbonyl group, and a butoxycarbonyl group); aryloxycarbonyl groups (such as a phenoxycarbonyl group); acyl groups (such as an acetyl group, a propionyl group, a butyloyl group, a benzoyl group, and an alkylbenzoyl group); ureido groups (such as a methylamonocarbonamide group, and a diethylaminocarbonamide group); urethane groups (such as a methoxycarbonamide, and a butoxycarbonamide); acyloxy groups (such as an acetyloxy group, a propionyloxy group, and a butyloyloxy group); or hydroxyl groups. These groups may further have a substituent group.

A₂ indicates a hydroxyl group or a substituted amino group. As a substituent group of the substituted amino group, listed are an alkyl group, an aryl group, and a heterocyclic group, and substituted groups may combine with each other to form a ring, and may further have a substituent group. R₂₄ and R₂₃, and R₂₁ and R₂₂ may combine with each other to form rings. A substituted amino group in A₂ may combine with either R₂₁ or R₂₄ to form a ring.

As examples of compounds represented by Formula (6), listed are each of the compounds described in JP-A 2002-55418, paragraphs [0125]-[0128].

Each of hologram preparation method of the present invention is characterized by the following hologram preparation method in which a silver halide photographic sensitized material for holograms is superimposed with a processing member including a silver bleaching agent and/or a silver halide fixing agent after thermal development of the sensitized material, in the presence of an aqueous medium, the volume of which is not less than 1/10 and not more than 100 times the volume required to maximally swell all the layers except the backing layer of the sensitized material.

In the present invention, the volume required to maximally swell all the layers except the backing layer of the sensitized material is defined as follows. The sensitized material is kept at an ambience of 40° C. and 60% RH for more than 48 hrs. before measurement, the mass weight per unit area of the sensitized material is designated as mass weight A. Next, distilled water is added to all of the composition layers of the sensitized material except the backing layer, and after the coated layers are sufficiently swelled, excessive distilled water on the surface of the sensitized material is wiped away with filter paper after which the mass weight per unit area of the sensitized material as mass weight B is determined. The volume required to maximally swell is defined as mass weight B−mass weight A (g/m²).

In cases when the applied volume of an aqueous medium to the sensitized material is less than 1/10 of the required volume for maximum swelling, processing unevenness tends to occur due to insufficient reactions during processing. Further, in cases when the applied volume of the aqueous medium is more than 100 times, the volume of a reaction liquid is adversely excessive, often resulting in generation of problems of staining the processing apparatus.

The processing member of the present invention means a sheet member to process the sensitized material superimposing to the processing member to conduct each process of development, bleaching and fixing. The member may have a substrate or not, and has a function to supply compounds having specific function such as a development processing, a bleaching process and a fixing process, and also has a function to maintain reaction solvents in the reaction field.

In the present invention, when using the processing member, processing is characterized by superimposing the processing member onto the sensitized material, instead of soaking the sensitized material in the processing solution, which eliminates the need for using chemical solutions, or can drastically reduce the volume of chemical solutions. Further, in this method, tanks for chemical solutions can be eliminated, resulting in floor space saving for stored processing tanks. Further, it tends to shorten the development time, and prevents staining of apparatus by chemical solutions. The processing member of the present invention may be a multi-layer structure, the same as commercially available films. In this case, an individual layer is called simply “a layer” or “a composition layer”. To these composition layers, a hydrophilic binder may be employed, and further binder compositions may be appropriately selected based on the function of the layer.

In the present invention, the expression “superimposing the sensitized material and the processing member” means that the substrate surface having a silver halide emulsion layer of the sensitized material and the substrate surface of the composition layer of the processing member are in tight contact. In the present invention, the processing member having a substrate preferably has combined functions, such as shielding against air during development, preventing diffusion of materials from the sensitized material, and eliminating materials in the sensitized material which become unnecessary after development as well as eliminating unnecessary materials formed during development.

As a substrate usable in the present invention, preferably used are synthesized plastic films, for example, polyolefins such as polyethylene and polypropylene, polycarbonates, cellulose acetates, polyethylene terephthalates, polyethylene naphthalate, and polyvinyl chlorides. Further, syndiotactic structure polystyrenes are also preferred. These may be obtained via polymerization methods described in, for example, JP-A Nos. 62-117708, 1-46912, and 1-178505. Further, as a substrate usable for the sensitized materials of the present invention, listed are paper substrates such as photographic base paper, printing paper, baryta paper, and resin coated paper; substrates providing a reflection layer on the foregoing plastic films; and substrates described in JP-A 62-253195, pp. 29-31.

Preferably used are the ones described in foregoing R. D. No. 17643, pg. 28; No. 18716, from the right column of pg. 647-the left column of pg. 648; and No. 307105, pg. 879. These substrates may be subjected to heat treatment at less than the Tg to acquire core-set curl resistance, as described in U.S. Pat. No. 4,141,735. Further, the surface of these substrates may be subjected to surface treatment to enhance adhesive property between the substrate and an emulsion subbing layer. As a surface treatment, usable are a glow discharge treatment, a UV radiation treatment, a corona discharge treatment, and a flame treatment. Further, the substrates described in Kochi Gijutsu (Public Knowledge) vol. 5, pp. 44-149, 22 Mar. 1991, published by AZTEC CORPORATION. It is possible to use transparent substrates such as polyethylene dinaphthalatedicarboxtlate, and substrates coated with a transparent magnetic material on the foregoing substrates.

Further, as usable substrates for the sensitized material of the present invention, listed are, for example, substrates described in R.D. No. 308119, on pg. 1009, and Product Licensing Index, vol. 92, pg. 108, in the section on “Supports”.

In cases when the sensitized material of the present invention is used for thermal development processing, it is essential to use substrates which withstand the processing temperature.

The aqueous medium in the present invention is water or a water soluble organic solvent. As these organic solvents, listed are methanol, ethanol and propanol. In the aqueous medium of the present invention, compounds soluble in water or a water soluble organic solvent may be incorporated, such as inorganic alkalin metal salts, organic bases, low boiling point solvents, surface active agents, anti-fogging agents, complex forming compounds with a very insoluble metal salt, mildewcides, and antimicrobial agents. As water, any generally used water may be employed, and specifically used are distilled water, tap water, well water and mountain spring water. Further, in the thermal development apparatus using the sensitized material and the processing member of the present invention, water may be used as one time use or repeated use following a recycling process. In the case of the latter, water containing components solved out from the material can be used, as well as a device and water described in JP-A Nos. 63-144354, 63-144355, 62-38460, and 3-210555. Water may be applied using methods appropriate for the sensitized material, to the processing member, or to both of them. The applied amount of water is equivalent to the volume of 1/10-100 times required to maximally swell all of the coated layers of the sensitized material, except the backing layer. As water applying methods, preferably used are those described in, for example, JP-A Nos. 62-253159, pg. 5, and 63-85544. Further, methods may be used in which solvents are sealed in microcapsules, or incorporated in the sensitized material, the processing member or both of them in advance in the form of hydrates.

Bleaching and fixing of the present invention indicate the processing described in Shasinkogaku no Kiso (Fundamentals of Photographic Engineering), edited by the Society of Photographic Science and Technology of Japan, published by CORONA PUBLISHING CO., LTD., 1979 1st printing, sections 4. 2. 3 and 4. 3. 3.

As a silver bleaching agent of the present invention, listed is aminopolycarboxylic acid ferric complex.salt hydrate, while more than two kinds of aminopolycarboxylic acid ferric complex.salt hydrate may be used in combination. Aminopolycarboxylic acid ferric complex salt hydrate is preferably used in the form of an iron complex of the free acid of the foregoing aminopolycarboxylic acid represented by following Formula (II), and further preferably used is the foregoing ferric complex in combination with a free acid of aminopolycarboxylic acid. Specifically preferred is use of the foregoing ferric complex in combination with the same kind of free acid of an aminopolycarboxylic acid as that composing the complex. Further, aminopolycarcoxylic acid ferric complex salt hydrate may be used in the form of a potassium salt, a sodium salt, or an ammonium salt. An aminopolycarboxylic acid can be used in the form of a free acid, a potassium salt, or a sodium salt of the aminopolycarboxylic acid.

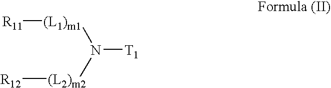

In this formula, T₁ indicates a hydrogen atom, a hydroxyl group, a carboxyl group, a sulfo group, a carbamoyl group, a phosphono group, a phosphone group, a sulfamoyl group, wherein each of the following groups may be substituted with an alkyl group, an alkoxy group, an alkylsulfonamide group, an alkylthio group, an acylamino group, a hydroxamic acid group, and a hydroxyalkyl group, or

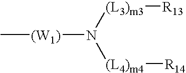

W₁ indicate an alkylene group, an arylene group, an alkenylene group, a cycloalkylen group, and an aralkylene group, each of which may be substituted, or -(L₅-X′)ₘ₅-(L₆)ₘ₆-; X′ indicates —O—, —S—, a divalent heterocyclic ring, or

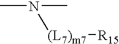

wherein R₁₁-R₁₅ indicate a hydrogen atom, a hydroxyl group, a carboxyl group, a sulfo group, a carbamoyl group, a phosphono group, a phosphone group, a sulfamoyl group, a sulfonacido group, an acylamino group, or a hydroxam group, and at least one of R₁₁-R₁₅ is a carboxyl group.

L₁-L₇ indicate an alkylene group, an arylene group, an alkenylene group, a cycloalkylene group or an aralkylene group, which are substituted or unsubstituted. m1-m7 indicate an integer of 0-6, but m5 and m6 can not be 0 at the same time.

Examples of aminopolycarboxylic acids represented by foregoing Formula (II) comprising an aminopolycarbpxylic acid ferric complex.salt hydrate include the compounds described in JP-A 9-90579, paragraph Nos. [0085]-[0091].

In the processing of the present invention, a silver oxidizing agent which functions as a bleaching agent is incorporated in the processing material to eliminate developed silver formed by development in the sensitized material, and this reaction is to be conducted during processing. Further, after finishing development of image formation, developed silver may be eliminated by the closely contacted second material containing a silver oxidizing agent.

As other bleaching agents usable in the present invention, generally used silver bleaching agents may optionally be employed. These bleaching agents are described in U.S. Pat. Nos. 1,315,464 and 1,946,640, and Photographic Chemistry, vol. 2, Chapter 30, published by Foundation Press, London, England. These bleaching agents effectively oxidize photographic silver images for subsequent solubilization. Examples of useful silver bleaching agents are alkali metal dichromates and alkali metal ferricyanide compounds. Preferable bleaching agents are ones soluble in water, and examples of these compounds include, for example, ninhydrin, indandione, hexaketocyclohexane, 2,4-dinitrobenzoic acid, benzoquinone, benzenesulfonic acid, and 2,5-dinitrobenzoic acid. Further, organic metal complexes are a ferric salt of cyclohexyldialkylaminotetraacetic acid, a ferric salt of ethylenediaminetetraacetic acid, and a ferric salt of citric acid.

The applied amount of a bleaching agent needs to be varied based on the contained silver amount in the sensitized material to be superimposed, and is commonly used in the range of 0.01-10 mols per mol of the coated silver amount of the unit area of the sensitized material. Preferable is 0.1-3 mol/coated silver mol, while more preferable is 0.1 -2 mol/coated silver mol.

As silver halide fixing agents used in the present invention, listed may be, for example, thiosulfates, sulfites, thiocyanates, thioether compounds, mercapto compounds, thiouracils, and nitrogen containing heterocyclic compounds having a sulfide group described in JP-A Nos. 4-365037, pgs. 11-21, and 5-66540, pgs. 1088-1092, and further nitrogen containing heterocyclic compounds such as tetraazaindenes, uracils, banzotriazoles; and hydantoins.

Further, thioether compounds such as 1,8-di-3,6-dithiaoctane, 2,2′-thiodiethanol, 6,9-dioxa-3,12-dithiatetradecane-1,14-diol, described in examined Japanese Patent Publication 47-11386 (hereinafter, referred to as JP-B); uracils described in JP-A 8-179458; compounds having a 5- or 6-membered imido ring such as hydantoin; as well as compounds represented by Formula (I) described in JP-A 53-144319. Also preferably used are mesoionic thiolate compounds such as trimethyltriazolium thiolate as described in Analytica Chemica Acta, vol. 248, pgs. 604-614, 1991. Compounds which can fix and stabilize silver halides, described in JP-A 8-89097 may be employed as a silver halide solvent. Further, fixing agents which dissolve at different temperatures of development, described in U.S. Pat. No. 2002/9,678 are also usable. Further, the foregoing silver halide dissolving agents may be used in combination.

Of the foregoing compounds, specifically preferable are sulfites, compounds having a 5- or 6-membered imido ring such as uracils and hydantoins. Uracils and hydantoins are preferably added in the form of a potassium salt to improve glossiness reduction of the sensitized material during storage.

The total silver halide solvent content in the processing layer is preferably 0.01-100 mmol/m², more preferably 0.1-50 mmol/m², and still more specifically preferably 1-30 mmol/m². The mol ratio of the silver salt solvent to the silver coverage in the sensitized material is preferably 1/20-20 times, more preferably 1/10-10 times, and specifically preferably ⅓-3 times.

The foregoing silver bleaching agents and silver halide fixing agents may be added to the processing layer after being dissolved into a solvent such as water, methanol, ethanol, acetone, dimethylformamide, and methylpropyl glycol, or into alkaline or acidic aqueous solution, or in the form of solid microscopic particles dispersion.

A hologram preparation method of the present invention is characterized by heating the sensitized material superimposed with a processing member containing physical development nuclei, a complex forming compound and a silver halide fixing agent, in the presence of an aqueous medium, the volume of which is not to be less than 1/10 and not more than 100 times the volume required to maximally swell the sensitized material, using the silver halide photographic sensitized material for holograms containing a insoluble metal oxide or a insoluble metal hydroxide.

In the hologram preparation method of the present invention, to eliminate unnecessary silver halides after image formation, a compound having a fixing function may be contained in the processing material. One example of these methods is a processing material that contains physical development nuclei after which a silver halide solvent and silver halide in the sensitized material is solubilized while heated to fix to the processing layer. Physical development nuclei reduce soluble silver salts diffused from the sensitized material which change to physically developed silver and fix into the processing layer. All of the compounds in the public domain as a physical development nuclei may be employed, for example, heavy metals such as zinc, mercury, lead, cadmium, iron, chromium, nickel, tin, cobalt, copper and ruthenium, noble metals such as palladium, platinum, silver and gold, or colloidal particles of a sulfuric, selenic, or tellurous chalcogen compound of these metals. These physical development nuclear compounds are obtaiable by forming a metallic colloidal dispersion solution by reducing a corresponding metal ion using a reducing agent such as ascorbic acid, sodium borohydride, and hydroquinone; or by forming an insoluble colloidal dispersion solution of a water insoluble metallic sulfide, a water insoluble metallic selenide or a water insoluble telluride, and then mixing the foregoing metal ion with a soluble sulfide, a soluble selenide or a soluble telluride. These dispersion solutions are preferably formed in a hydrophilic binder such as gelatin. A preparation method of colloidal silver particles is described, for example, in U.S. Pat. No. 2,688,601. According to need, any desalting treatment to remove excessive salts, known in silver halide emulsion preparation methods, may be conducted. The employed size of these physical development nuclei is preferably 2-200 nm in diameter. These physical development nuclei are generally contained in the processing layer at 1×10⁻³−100 mg/m², and preferably 1×10⁻²−10. Physical development nuclei separately prepared may be added into a coating composition, or the nuclei may be prepared in a coating composition containing a hydrophilic binder and allowed to react, for example, silver nitrate and sodium sulfide, or gold chloride and a reducing agent. As physical development nuclei, silver, silver sulfide or palladium sulfide is preferably employed.

In cases when fixing of silver halide is conducted using these methods, required is to exist a reducing agent possible to set up physical development. In cases when a non-diffusive reducing agent is employed, it is necessary to add the agent into the layer, but in the case of diffusive reducing agents, the reducing agent may be added to any layer of the sensitized material or the processing layer.

As a reducing agent having these functions, an auxiliary developing agent is preferably employed. The term “auxiliary developing agent” means a compound having the function to accelerate transfer of electrons from a developing agent to silver halide. The auxiliary developing agent may be added to an applying aqueous medium, but may be incorporated into the sensitized material in advance. A developing method using an alkaline aqueous solution containing an auxiliary developing agent is described in R. D. No. 17643, pgs. 18-29, No. 18716, pg. 651 left column-right column, and No. 307105, pgs. 880-881. Auxiliary developing agents of the present invention are preferably electron releasing compounds following the Kendall-Perutz law, and being represented by Formula (ETA-I) or Formula (ETA-II) described in JP-A 2002-23296, paragraphs [0118]-[0123]. Of these, the compounds represented by Formula (ETA-I) are specifically preferable. Further, in cases when an auxiliary developing agent is incorporated in the sensitized material, to enhance storage stability of the sensitized material, the auxiliary developing agent may be incorporated in the form of a precursor. Examples of usable auxiliary developing agent precursors include compounds (ETP-1)-(ETP-97) described in JP-A 2000-89425. These compounds may be added and coated by dissolution into an adequate solvent such as water, alcohols, acetone, dimethylformamide, and glycols, by microscopic particle dispersion, or by conducting microscopic particle dispersion into a hydrophilic binder after dissolving them in a high boiling solvent such as tricresyl phosphate. These auxiliary developing agent precursors may be used in combination of more than two, or in combination with an auxiliary developing agent.

In the present invention, a complex forming compound enabling formation of a complex with a metallic ion of a metal oxide or a metal hydroxide which is insoluble in water may be contained in the processing member. Examples of usable complex forming compounds include aminocarboxylic acids such as ethylenediaminetetraacetic acid, nitrilotriacetic acid, and diethylenetriaminepentaacetic acid, and their salts; aminophosphonic acid and its salt; pyridylcarboxylic acids such as 2-picolinic acid, pyridine-2,6-dicarboxylic acid, and 5-ethyl-2-picolinic acid and their salts; as well as iminodiacetic acids such as benzyliminodiacetic acid, and α-picolyliminodiacetic acid and their salts. These complex forming compounds are preferably used in the form of salts neutralized with an organic base such as guanidine or an alkaline metal such as potassium. The preferable amount added of the complex forming compound to the processing member is 0.1-20 g/m², and more preferably 0.5-10. In the present invention, a zinc ion is the preferable metallic ion with which the complex forming compounds enable to form a complex.

The silver halide emulsion of the present invention may be subjected to nuclear formation in the presence of low molecular weight gelatin of 5,000-70,000 and/or gelatin with a methionine content of not more than 30 μmol/g. The methionine content of gelatin during nuclear formation is preferably not more than 20 μmol/g, and more preferably 0.1-10. The average molecular weight of the low molecular gelatin is preferably 6,000-50,000, and more preferably 7,000-30,000.

To reduce the methionine content in gelatin to not more than 30 μmol/g, effective is an oxidation treatment of alkali process gelatin using an oxidizing agent. The oxidizing agents usable for the oxidization treatment include, for example, hydrogen peroxide, ozone, peroxy acid, halogen, thiosulfonic acid compound, quinines, and organic peracid. In the present invention, hydrogen peroxide is preferred. The silver halide emulsion of the present invention may be used to remove unnecessary soluble salts after growth of silver halide particles, or may remain in the salts. In cases when the salts are removed, desalting is conducted based on the methods described in R. D. No. 17643, section II. Further, in the present invention, more than two kinds of silver halide emulsions prepared separately may be employed with optional mixing. In the present invention, used may be silver halide emulsions prepared with the methods described in JP-A Nos. 2002-55410, paragraphs [0054]-[0065], and 6-118593, paragraphs [0060]-[0078].

To provide color sensitivity such as green sensitivity or red sensitivity to the photosensitive silver halide used in the present invention, this can be achieved by providing spectral sensitization to the photosensitive silver halide emulsions using methine dyes. Further, if necessary, blue sensitive emulsion is subjected to spectral sensitization in the blue region. Examples of usable dyes in the present invention include cyanine dyes, merocyanine dyes, complex cyanine dyes, complex merocyanine dyes, holopolar cyanine dyes, hemicyanine dyes, styryl dyes and hemioxonol dyes. Specifically listed are dyes described in U.S. Pat. No. 4,617,257, JP-A Nos. 59-180550, 64-13546, 5-45828, and 5-45834. These dyes may be used alone or in combination, and a combination of sensitizing dyes is often subjected to wavelength control for super sensitization or spectral sensitization. Together with sensitizing dyes, the compounds which exhibit super spectral sensitization except for dyes not having a function of spectral sensitization themselves or compounds substantially not absorbing visible light, may be contained in the emulsion. For example, listed are the compounds described in U.S. Pat. No. 3,615,641, and JP-A 63-23145. The period to add these sensitizing dyes into the emulsion may be during chemical ripening or before or after that, or before or after the nuclear formation of silver halide particles according to U.S. Pat. Nos. 4,183,756 and 4,225,666. Further, these sensitizing dyes and super spectral sensitizing agents may be incorporated in the form of a solution dissolved in an organic solvent such as methanol, a dispersion solution of gelatin, or a solution dissolved in a surface active agent. The added amount is generally about 1×10⁻⁸-1×10⁻² mol per mol of silver halide.

In the silver halide photographic sensitized material for holograms of the present invention, various technologies and addition agents both of which are within the industry's public domain, may be employed. For example, in addition to the sensitized silver halide emulsion layer, auxiliary layers such as a protective layer, a filtering layer, an anti-halation layer, a cross-over light cutting layer, and a backing layer, can be provided. To these layers, employing various methods, may be various kinds of chemical sensitizing agents, noble metal sensitizing agents, sensitizing dyes, super spectral sensitizing agents, couplers, high boiling point solvents, anti-fogging agents, stabilizing agents, development inhibitors, bleaching accelerators, fixing accelerators, color mixture inhibitors, formalin scavengers, image color controlling agents, hardening agents, surface active agents, viscosity increasing agents, plasticizers, slippage agents, UV absorbing agents, anti-irradiation dyes, filter light absorbing dyes, mildewcides, polymer latexes, heavy metals, anti-static agents, and matting agents.

The details of addition agents are described in, for example, Research Disclosure, vol. 176, Item/17643, Dec. 1978, vol. 184, Item/18431, Aug. 1979, vol. 187, Item/18716, Nov. 1979, and vol. 308, Item/308119, Dec. 1989.

The kinds of the compounds and the places described in the aforementioned R. D.s are listed in Table 1.

TABLE 1

| | | | RD-18716 | | |
|---|---|---|---|---|---|
| | RD-17643 | | Page | RD-308119 | |
| Addition agent | Page | Classification | Classification | Page | Classification |
| Chemical sensitizing agent | 23 | III | 648 Upper right | 996 | III |
| Sensitizing dye | 23 | IV | 648 to 649 | 996 to 998 | IVA |
| Desensitizing dye | 23 | IV | | 998 | IVB |
| Dye | 25 to 26 | VIII | 649 to 650 | 1003 | VIII |
| Development accelerator | 29 | XXI | 648 Upper right | | |
| Anti-fogging agent | 24 | VI | 649 Right | 998 to 1000 | VI |
| Stabilizer | | | | | |
| Brightening agent | 24 | V | 647 Right | 998 | V |
| Hardening agent | 26 | X | 651 Upper left | 1004 to 1005 | X |
| Surface active agent | 26 to 27 | XI | 650 Lower right | 1005 to 1006 | XI |
| Anti-static agent | 27 | XIII | 650 Lower right | 1006 to 1007 | XIII |
| Plasticizer | 27 | XII | 650 Lower right | 1006 | XII |
| Slippage agent | 27 | XII | 650 Lower right | | |
| Matting agent | 28 | XVI | 650 Right | 1008 to 1009 | XVI |
| Binder | 26 | IX | 651 Left | 1003 to 1004 | IX |
| Substrate | 28 | XVII | | 1009 | XVII |

In the present invention, decolorizing dyes such as a lueco dye are preferably employed. Specifically, listed is a lueco dye colorized in advance using a developer of organic acid metal salts described in JP-A 1-150132. A lueco dye and a developer complex react to decolorize via heat or an alkali agent. Therefore, in the present invention, the combination of this type of lueco dye and a developer is preferred. Lueco dyes within the public domain may be employed, and are described in Senryo to Yakuhinn (Dyes and Chemicals), by Moriga and Yoshida, vol. 9, pg. 84, edited by Kaseihin Kogyo Kyokai; Sinpan Senryou Binran (new edition of Handbook on Dyes), pg. 242, published by MARUZEN CO., LTD.; Reports on the Progress of Applied Chemistry, vol. 56, pg. 199, 1971; Senryo to Yakuhin (Dyes and Chemicals), vol. 19, pg. 230, edited by Kaseihin Kogyo Kyokai; Sikizai (Coloring Materials), vol. 62, pg. 288, 1989; and Senryo Kogyo (Dye Industry), vol. 32, pg. 208. As a developer, preferably employed are acid clay type developers, phenolformaldehyde resins, and matal salts of organic acids.

In the sensitized materials of the present invention, with a view of enhancing sensitivity and developability, if appropriate, organic silver salts within the public domain may be employed. Organic silver salts usable in the present invention include, for example, silver salts of long chained aliphatic carboxylic acids or silver salts of carboxylic acids having a heterocycle [such as silver behenate, and α-(1-phenyltetrazolethio)silver acetate]], described in JP-A Nos. 53-4921, 49-52626, 52-141222, 53-36224, 53-37626, 53-36224, and 53-37610, U.S. Pat. Nos. 3,330,633, 3,794,496, and 4,105,451; or silver salts of compounds having an imino group described in JP-B Nos. 44-26582, 45-12700, 45-18416, 45-22815, JP-A Nos. 52-137321, 58-118638, and 58-118639, and U.S. Pat. No. 4,123,274. Further, silver acetylides described in JP-A 61-249044 may also be employed. Also, silver salts of complexes with compounds having a mercapto group and silver described in WO No. 01/96949 and WO No. 01/96950 may be employed. Of these, preferable are silver salts of benzotriazole and its derivatives (such as silver benzotriazolate, and 5-methylbenzotriazolate), silver behenate, and a silver complex of 1-phenylmercapto-tetrazole. The foregoing organic silver salts may be employed alone or in combination of more than two. These salts may be prepared in a hydrophilic colloidal solution such as gelatin, and may be used directly as they are after removal of soluble salts, or may be used after isolation, mechanically grinding to minute solid particles and dispersing. The foregoing organic silver salts may be used in combination at 0.01-10 mol per mol of sensitized silver halide, and preferably 0.05-3. The total of the coated silver amount of photosensitized silver halide and organic silver salts is generally 0.05-30 g/m² in silver conversion, and preferably 0.1-15 g/m².

Examples of anti-fogging agents usable in the present invention include, for example, higher fatty acids described in U.S. Pat. No. 3,645,739; mercuric salts described in JP-B 47-11113; N-halides described in JP-A 51-47419; mercapto compound releasing compounds described in U.S. Pat. No. 3,700,457, JP-A Nos. 51-50725, 2-297548, and 2-282241; arylsulfonic acids described in JP-A 49-125016; lithium carboxylates described in JP-A 51-47419; oxidizing agents described in British Patent No. 1,455,271 and JP-A 50-101019; sulfinic acids and thiosulfonic acids described in JP-A 53-19825; thiouracils described in JP-A 51-3223; sulfur described in JP-A 51-26019; disulfides and polysulfides described in JP-A Nos. 51-42529, 51-81124 and 55-93149; rosin or diterpenes described in JP-A 51-57435; polymer acids having a carboxyl group or a sulfo group described in JP-A 51-104338; thiazolithions described in U.S. Pat. No. 4,138,265; triazoles described in JP-A Nos. 54-51821, 55-142331, and U.S. Pat. No. 4,137,079; thiosulfinates described in JP-A 55-140883; di- or tri-halides described in JP-A Nos. 59-46641, 59-57233, and 59-57234; thiol compounds described in JP-A 59-111636; and hidroquinone derivatives described in JP-A Nos. 60-198540, and 60-227255. Further, as additional preferable anti-fogging agents, listed are anti-fogging agents having a hydrophilic group described in JP-A 62-78554, polymer anti-fogging agents described in JP-A 62-121452, anti-fogging agents having a ballast group described in 62-123456. Still further, colorless couplers described in JP-A 1-161239 may be preferably employed. As other anti-fogging agents, the foregoing organic silver salts and compounds described in JP-A Nos. 4-171443 and 4-73649 may also be employed as appropriate.

In the present invention, various anti-fogging agents, photographic stabilizers and their precursors may be employed. Examples of these compounds include the compounds described in foregoing Research Disclosures (R. D.), U.S. Pat. Nos. 5,089,378, 4,500,627, 4,614,702, JP-A 64-13564, pp. (7)-(9), (57)-(71) and (81)-(97), U.S. Pat. Nos. 4,775,610, 4,626,500, 4,983,494, JP-A Nos. 62-174747, 62-239148, 1-150135, 2-110557, 2-178650, R. D. No. 17643, pp. (24)-(25), 1978, European Patent Nos. 1,164,419 and 1,164,421, and JP-A Nos. 2002-23326 and 2002-31878.

These compounds may be preferably employed at 5×10⁻⁶−10 mol per mol of silver, and more preferably 1×10⁻⁵−5.

In the present invention, as binders of the composition layers of the sensitized material and/or the processing material, hydrophilic ones may be preferably employed. Examples of the binders include ones described in foregoing Research Disclosure and JP-A 64-13546, pp. (71)-(75). Further, binders suitable to the present invention are transparent or opaque, but generally colorless. Listed are natural polymers, synthesized resins, polymers and copolymers, and other film forming materials, for example, are gelatin, gum arabic, poly(vinyl alcohol), hydroxyethyl cellulose, cellulose acetate, cellulose acetate butyrate, poly(vinyl pyrrolidone), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinyl acetals) such as poly(vinyl formal) and poly(vinyl butyral), poly(esters), poly(carbonates), poly(vinyl acetate), cellulose esters, and poly(amides).

In the present invention, to reduce fogging after thermal development, hydrophobic transparent binders may be employed. As these binders, listed are polyvinyl butyral, cellulose acetate, cellulose acetate butyrate, polyester, polycarbonate, polyacrulic acid, and polyurethane. Of these hydrophobic binders, polyvinyl butyral, cellulose acetate, cellulose acetate butyrate, and polyester are specifically preferable.

These binders may be employed in combination of more than two kinds, and the used amount of the binders is preferably less than 100 g/m², and specifically less than 20 as appropriate.

The sensitized material and/or the processing material of the present invention are preferably hardened using a hardening agent. In cases when a hydrophilic binder such as gelatin is employed as a binder, as a preferable hardening agent, listed are hardening agents described in U.S. Pat. Nos. 4,678,739, column 41, and 4,791,042, as well as JP-A Nos. 59-116655, 62-245261, 61-18942, 61-249054, 61-245153, and 4-218044. More specifically, listed are aldehyde type hardening agents (such as formaldehyde), vinyl sulfone type hardening agents [such as N,N′-ethylene-bis(vinyl sulfonyl acetamide)ethane], N-methylol type hardening agents (such as dimethylolurea), boric acid, metaboric acid, or polymer hardening agents (such as compounds described in JP-A 62-234157). Of these hardening agents, vinyl sulfone type hardening agents and chlorotriazine type hardening agents are preferably employed alone or in combination. These hardening agents are used at 0.001-1 g per g of a hydrophilic binder, and preferably 0.005-0.5 g.

The present invention characterized in that a photographic sensitized material for hologramic recording is subjected to activator processing. Activator processing in the present invention means a processing method to conduct development processing using a processing solution containing no developing agent, while a developing agent or a developing agent precursor is incorporated in the sensitized material or the processing material. In this case, the processing solution is characterized by not containing a developing agent which is usually contained in a developing solution, but may contain other compositions such as alkaline and an auxiliary developing agent. Regarding activator processing, it is explained with examples in documents in the industry's public domains such as European Patent Nos. 545,491A and 565,165A. The pH of activator processing solution used in the present invention is preferably 9 or more, and more preferably 10 or more.

The preferable processing form of the sensitized material of the present invention is thermal development (referred to also as heat development). In thermal development, the sensitized material may be heated to develop as it is, or to develop as it is superimposed with a processing material other than the sensitized material. As a processing material, listed is a sheet having a processing layer on a substrate, said layer containing a base and/or a base precursor. The processing layer preferably comprises a hydrophilic binder. After the sensitized material is image exposed, image formation is achieved by heating after the sensitized material and the processing material are overlapped to contact the sensitized layer surface of the sensitized material and the processing layer surface of the processing material. In the present invention, preferably employed is a method in which after water at a volume of which is 1/10-100 times the volume required to maximally swell all coated layers of the sensitized material, as well as the processing layer, is applied to the sensitized material or the processing material, both materials are overlapped together and heated to allow color development. Further, employed may be a method to incorporate the foregoing auxiliary developing agent in the sensitized material or the processing material as appropriate, or to coat the auxiliary developing agent together with water.

Heat processing of the sensitized material is well known in the industry, and a thermal development sensitized material and its processing are described in, for example, Shasinkogaku no Kiso (Fundamentals of Photographic Engineering, pp. 553-555, published by CORONA PUBLISHING CO., LTD., 1970; Eizo Joho (Image Information), pg. 40, Apr. 1978; Nabletts Handbook of Photography and Reprography, 7^{th} Ed., pp. 32-33, Van Nostrand and Reinhold Company; U.S. Pat. Nos. 3,152,904, 3,301,678, 3,392,020, and 3,457,075; British Patent Nos. 1,131,108 and 1,167,777; Research Disclosure No. 17029, pp. 9 -15, Jun. 1978. Heating temperature of a thermal development process is 50-250° C., and specifically useful is 60-150° C.

To the sensitized material of the present invention, a thermo solvent may be added to accelerate thermal development. A thermo solvent is a compound which liquefies during heating and functions to accelerate image formation. It is preferable to be white and in a solid-state at ambient temperatures, and desirably has a low volatility during heating, while the preferred melting point is 70-170° C. As examples, listed are the organic compounds having a polar group described in U.S. Pat. Nos. 3,347,657 and 3,667,959, and specifically amide derivatives (such as benzamide), urea derivatives (such as methyl urea and ethyl urea), sulfonamide derivatives (such as the compounds described in JP-B Nos. 1-40974 and 4-13701), polyol compounds, sorbitols, and polyethylene glycols. In addition to these, as thermo solvents usable in the present invention, listed are, for example, the compounds described in U.S. Pat. Nos. 3,347,675, 3,438,776, 3,666,477 and 3,667,959, R. D. No. 17643, JP-A Nos. 51-19525, 53-24829, 53-60223, 58-118640, 58-198038, 59-68730, 59-84236, 59-229556, 60-14241, 60-191251, 60-232547, 61-52643, 62-42153, 62-44737, 62-78554, 62-136645, 62-139545, 63-53548, 63-161446, 1-224751, 1-227150, 2-863, 2-120739 and 2-123354. Further, as specific examples of thermo solvents usable in the present invention, listed are TS-1-TS-21 described in JP-A 2-297548, upper left of pg. 8 to upper left of pg. 9. The foregoing thermo solvents may be employed in combination of more than two kinds.

When the sensitized material of the present invention is subjected to the thermal development, any heating means being within the public domain may be employed, for example, a method to bring the sensitized material into contact with a heated block or a heated plane, a heated roller or a heated drum, or an infrared and a far infrared heater, a method to direct the sensitized material through an ambient atmosphere maintained high temperature, or a method to use a high-frequency induction heating. In addition to these, aapied may be a method to utilize Joul heat generated by electrically energizing an electrically conductive material such as a carbon black layer which is provided on the back of the sensitized material or the processing material. As a heat generating element, the ones described in JP-A 61-145544 may be employed. As methods to superimpose the sensitized material and the processing material in a face-to-face mode of the sensitized layer and the processing layer, applied may be methods described in JP-A Nos. 62-253159 and 61-147244, pg. 27.

For processing of the photographic element of the present invention, various thermal development apparatuses may be utilized. For example, preferably utilized are apparatuses described in JP-A Nos. 59-75247, 59-177547, 59-181353 and 60-18951, unexamined Japanese Utility Model Application 62-25944, JP-A Nos. 6-130509 and 6-95338 and examined Japanese Patent 2863674, JP-A Nos. 8-29955 and 8-29954. Further, as commercially available apparatuses, utilizable are Pictrostat 100, Pictrostat 200, Pictrostat 300, Pictrostat 330, Pictrostat 50, Pictrography 3000 and Pictrography, all of which are manufactured by FUJI PHOTO FILM CO., LTD.

To the sensitized material and the processing material of the present invention, employed may be various surface active agents to function as a coating aid agent, improvement of strippability, improvement of slippage property, anti-static property, and acceleration of development. Examples of surface active agents are described in Kochi Gijutsu (Public Knowledge), vol. 5, pp. 136-138, 22 Mar. 1991), published by AZTEC CORPORATION, JP-A Nos. 173463 and 62-183457. To the sensitized material of the present invention, organic fluoro compounds may be contained for the purpose of an anti-slippage agent, an anti-static agent, and improvement of strippability. As typical examples of organic fluoro compounds, listed may be fluoric surface active agents described in JP-B 57-9053, columns 8-17, JP-A Nos. 61-20944 and 62-135826; and hydrophobic fluoric compounds such as oily fluoric compounds such as fluorinated oil, or solid fluoric compounds such as ethylenetetrafluoride resin.

The sensitized material and the processing material of the present invention preferably possess slippage property. A slippage agent is preferably added to both the sensitized layer and the backing layer of the sensitized material. Preferable slippage property is 0.25 or less and exhibits 0.01 or more of kinetic friction coefficient. The measurement of kinetic friction coefficient is conducted by transferring the object at 60 cm/min. with respect to a 5 mm diameter stainless steel sphere at 25° C. and 60% RH.

In this evaluation, preferable is a measuring member exhibiting almost the same level as the member replaced by the sensitized layer. As usable slippage agents, used may be a polyorganosiloxane, a high fatty acid amide, a high fatty acid metal salt, and an ester of a fatty acid and a higher alcohol. polydimethylsiloxane, polydiethylsiloxane, polystyrylmethylsiloxane, and polymethylphenylsiloxane may also be employed as polyorganosiloxanes. The added layer is preferably the outermost layer of the emulsion layer or the backing layer. Specifically, preferred are polydimethylsiloxane and an ester having a long chain alkyl group.

Further, in the sensitized material and the processing material of the present invention, an anti-static agent is preferably employed. As anti-static agents, listed are a carboxylic acid and a carboxylate, a polymer containing a sulfonate, a cationic polymer, and an ionic surface active agent compound. The most preferable anti-static agents are microscopic particles of crystalline metal oxides or their complex oxides (being Sb, P, B, In, S, Si and C), and further sol metal oxides or microscopic particles of their complex oxides, which may be chosen from ZnO, TiO₂, SnO₂, Al₂O₃, In₂O₃, SiO₂, MgO, BaO, MoO₃, and V₂O₅, and at least one of which is to exhibit volume resistivity of not more than 1×10⁷ Ω·cm, and more preferably 1×10⁵ Ω·cm, and a particle size of 0.001-1.0 μm. The added amount to the silver halide photographic sensitized material is preferably 5-500 mg/m², and specifically preferably 10-350. The ratio of electrically conductive crystalline oxides or their complex oxides to a binder is preferably 1:300-100:1, and more preferably 1:100-100:5.

To the compositions (including the backing layer) of the sensitized material and the processing material, various polymer latexes may be contained for the purpose of improvement of physical characteristics of the coated layers, such as dimensional stability, curling reduction, adhesion prevention, cracking prevention of the coated layers, and prevention of sensitization and desensitization due to pressure. Specifically, any polymer latexes described in JP-A Nos. 62-245258, 62-136648 and 62-110066 may be employed. Specifically, when a low glass transition point polymer latex is incorporated in the mordanting layer, cracking of the mordanting layer is prevented, while a reduced curling effect may be obtained by use of a high glass transition point polymer latex in the backing layer.

To the sensitized material and the processing material of the present invention, it is preferred to use a matting agent. A matting agent may be added to either the emulsion layer or the backing layer, and specifically preferred is to add it to the outermost layer of the emulsion side. A matting agent may be soluble or insoluble to the processing solution, and preferably is to use both kinds in combination. For example, polymethyl methacrylate, poly[methyl methacrylate/methacrylic acid=9/1 or 5/5 (mol ratio)], and polystyrene particles are preferable. The particle size is preferably 0.8-10 μm, and the particle size distribution is preferably narrow, and more than 90% of the total particle number is preferably contained between 0.9-1.1 times of the average particle size. Further, to enhance matting property, addition of microscopic particles of less than 0.8 μm at the same time is also preferable, and listed as such are, for example, polymethyl methacrylate (0.2 μm), poly[methyl methacrylate/methacrylic acid=9/1 (mol ratio), 0.3 μm], polystyrene particles (0.25 μm), and colloidal silica (0.03 μm). Specifically, the preferable particles are described in JP-A 61-88256, pg. 29. In addition, usable are compounds such as benzoguanamine resin beads, polycarbonate resin beads, and AS resin beads, described in JP-A Nos. 63-274944 and 63-274952. Further, the compounds described in the foregoing Research Disclosure may also be employed.

Thermal development of the silver halide photographic sensitized material for holograms of the present invention may include methods of thermal development to heat only the sensitized material, to heat the sensitized material superimposed to the processing number, or to heat the sensitized material in a developing solution bath, however the preferable method is one which does not use a processing bath.

Examples of the processing of the sensitized material of the present invention will be described below, but the present invention is not limited to these examples.

Development (processing bath)—Bleaching (processing bath)

Development (processing bath)—Fixing (processing bath)

Development (processing bath)—Bleaching (processing bath)—Fixing (processing bath)

Development (processing bath)—Bleach-fixing (processing bath)

Development (thermal development)—Bleaching (processing bath)

Development (thermal development)—Fixing (processing bath)

Development (thermal development)—Bleach-fixing (processing bath)

Development (thermal development)—Bleaching (processing member processing)

Development (thermal development)—Fixing (processing member processing)

Development (thermal development)—Bleaching (processing member processing)—Fixing (processing member processing)

Development (thermal development)—Bleach-fixing (processing member processing)

Development and fixing simultaneously (processing member processing)

With each combination of the foregoing processing, it is possible to prepare a phase type or an amplitude type recording material for holograms, while from a diffusion efficiency viewpoint, it is preferable to chose a method which enables preparation of a phase type, leaving no developed silver. Further, development may be the forgoing activator processing, or washing processing or stabilizing bath processing may be employed for the final processing.

As an exposure light source for the silver halide photographic sensitized material for holograms of the present invention, generally preferred is conducting image exposure using a laser light of visible region wavelength with uniform phases. Further, in image reproduction, light having the same wavelength as that of image forming laser light is the most primary function. From this point of view, in the unexposed area of the sensitized material after processing, obtained is the preferable reproduced image which does not absorb light having the same wavelength as that of image forming laser light. As laser light of visible region wavelengths, employed are, for example, a Nd:YAG laser, a Kr laser, an Ar laser, a HeNe laser, and a semiconductor laser. Further, a solid-state laser and an SHG laser resonator described in JP-A 8-160479 may be employed.

A hologram preparation system of the present invention is characterized by recording holographic stereogarams based on image information, onto a silver halide photographic sensitized material for holograms, in which image information for holographic sterograms is formed by providing image computation onto a plurality of images captured by a digital camera.

“Holographic stereograms of the present invention” means a method to sequentially expose these plural images onto a hologram recording material as elemental holograms (in the form of islands or strips), using a plurality of planar images from different locations as an original picture. For example, when plural images of a lateral direction are captured and the elemental holograms are recorded laterally as the strips of the longitudinal direction, holograms in which images differing from either side are viewable to both of the observer's eyes, can be obtained.

Holographic stereograms is a favorable method because it does not use the following complex and precise process which is required to make usual holograms. In order to make a usual type of holograms, a laser light is irradiated to an object to obtain the diffraction light from the object, and then, the diffraction light is recorded onto a photosensitive material.

Image computation processing for holographic stereograms of the present invention, is, for example, viewpoint conversion processing of each captured image, and consequently, the viewpoint conversion process may be subjected for the reproduced images to be located in the vicinity of the hologram side of holographic stereograms. As other image computation processing, listed are morphing processing to make smooth image continuity, and image processing to compose images with other images in text format. To record holographic stereograms onto silver halide photographic sensitized material for holograms using the images after computational image processing, possible apparatuses to display optically image information as original images, may be employed, and for example, a liquid crystal display is listed. After forming holographic stereograms, image holograms possible to be reproduced by white light using those as original images can be prepared.

A hologram forming system of the present invention is characterized by recording optically displayed images of interference fringe patterns by reduction exposure on the silver halide photographic sensitized material for holograms, after computing hologram interference fringe patterns based on plural images captured by a digital camera. “Computation of interference fringe patterns” means synonymously the technique used in calculator holograms of an interference measuring system, and usage of Fourier Transform type holograms is favorably employed from the viewpoint of computation load. An optical display for interference fringe patterns is preferably one exhibiting resolution of less than 100 lines/mm, and the patterns may be outputted on recording paper such as ink-jet paper, or on a liquid crystal display apparatus. Hologram images can be obtained by reduction exposure of this optical display of interference fringe patterns on silver halide photographic sensitized material for holograms having a resolution of 2,000-10,000 lines/mm, which is required for holograms.

In the present invention, preferred is conducting image computation of various hologram data through computation of luminance information, color information and location information of an object using a plurality of images captured by a digital camera.

In the present invention, preferred is forming holograms using the silver halide photographic sensitized material of the present invention, and is one of the methods of the present invention. Further, it is preferable to form holograms using one of the methods of the present invention combining with either system of the present invention.

### EXAMPLES

The present invention will be explained further based on examples on the following paragraphs, but is not limited to these examples.

### Example 1

Preparation of Silver Halide Emulsion

Based on the following method, two kinds of silver halide emulsions were prepared.

Preparation of Silver Halide Emulsion Em-1

| A solution | | |
|---|---|---|
| Purified water | 833 | ml |
| Gelatin | 80 | g |
| KBr | 0.5 | g |
| B solution | | |
| Silver nitrate | 60 | g |
| Purified water | 417 | ml |
| C solution | | |
| KBr | 42 | g |
| KI | 2.9 | g |
| Purified water | 403 | ml |
| Ammonia water | 14.3 | ml |

The foregoing A solution was added to a mixing vessel, and then B solution and C solution were double-jetted over 65 seconds at 50° C. 10 seconds after finishing the addition, 6 ml of 40% citric acid was added to adjust the pH.

After cooling to set the obtained emulsion, desalting was conducted employing a noodle washing method. This emulsion was designated Silver Halide Emulsion Em-1. The average particle size of obtained Silver Halide Emulsion Em-1 was 0.035 μm, and the degree of monodispersion (the standard deviation σ/the average particle size r) was 0.07.

Then, sodium thiosulfate was added at 15 mg per g of silver to obtained Silver Halide Emulsion Em-1 to provide chemical ripening at 60° C. for 90 minutes.

Preparation of Silver Halide Emulsion Em-2

Silver Halide Emulsion Em-2 was prepared in the same manner as Em-1 except that after finishing of addition of B and C solutions, the mixture's temperature was raised to 60 ° C.; after ripening for 10 minutes, the temperature was brought to 50° C.; and 6 ml of 40% citric acid was added to adjust the pH. The average particle size of obtained Silver Halide Emulsion Em-2 was 0.11 μm, while σ/r=0.08.

After that, sodium thiosulfate was added at 15 mg per mol of silver to obtained Silver Halide Emulsion Em-2 after chemical ripening at 60° C. for 90 minutes.

Preparation of Sensitized Material

Preparation of Sensitized Material 1

Using Silver Halide Emulsion Em-2 obtained above, the emulsion layer coating composition described in the following paragraph was prepared, and further, each of the coating compositions of a protective layer, a backing layer and a backing protective layer was prepared.

Each of the foregoing coating compositions was applied with a simultaneous multilayer coating method onto one surface of a 175 μm biaxially-stretched polyethylene terephthalate substrate using a simultaneous multiplayer coater of a slide hopper method, for a silver coverage of 2 g/m², a gelatin coverage of 1.6 g/m² as a lower layer, and a gelatin coverage of 0.4 g/m² as an upper layer, both of a protective layer.

Further, to the opposite surface of the foregoing substrate provided the emulsion layer, a simultaneous multiplayer coating of an emulsion layer was conducted using a similar coating method, for a silver coverage of 2 g/in² and a gelatin coverage of 1.6 g/m² as a lower layer and a gelatin coverage of 0.8 g/m² as an upper layer both being for a protective layer, after which drying was conducted to prepare Sensitized Material 1.

The added amount of each additive agent to the emulsion. layer described below is shown by as the amount per mol of silver, and the added amounts to the other layers is shown by the coated amount per m².

Emulsion Layer Coating Composition

| | | |
|---|---|---|
| Dye-A | 0.011 | mol |
| Compound A | 0.2 | g |
| Compound B | 3.4 | g |
| Compound (4) | 0.2 | g |
| Compound (5) | 0.3 | g |
| Gelatin | amounting to 1.6 | g/m² |
| 4% formalin solution | 0.14 | g per g of gelatin |

Protective Layer Coating Composition

| | | |
|---|---|---|
| Gelatin | 0.4 | g |
| Sodium-i-amyl-n-decyl-sulfosaccinate | 20 | mg |
| Compound (1) | 18 | mg |
| Compound (2) | 5 | mg |
| Compound (3) | 44 | mg |
| Pesticide Z | 0.6 | mg |
| 4% formalin solution | 0.8 | ml |

Backing Layer Coating Composition

| | | |
|---|---|---|
| Gelatin | 1.6 | g |
| Dye 1 | 45 | mg |
| Dye 2 | 40 | mg |
| Sodium-i-amyl-n-decyl-sulfosaccinate | 4 | mg |
| Potassium nitrate | 50 | mg |
| 4% formalin solution | 1.0 | ml |

Backing Protective Layer Coating Composition

| | | |
|---|---|---|
| Gelatin | 0.8 | g |
| Dye 1 | 18 | mg |
| Dye 2 | 16 | mg |
| Sodium-i-amyl-n-decyl-sulfosaccinate | 30 | mg |

Polymethyl methacrylate (being a matting agent at an

| | | |
|---|---|---|
| Polymethyl methacrylate | 30 | mg |
| (being a matting agent at an | | |
| average area particle size | | |
| of 3.5 μm) | | |
| Compound (3) | 0.1 | g |
| 4% formalin solution | 0.4 | ml |

Sensitized Material 2 was prepared in the same manner as preparation of foregoing Sensitized Material 1, except that Silver Halide Emulsion Em-1 was used instead of Silver Halide Emulsion Em-2.

Preparation of Sensitized Material 3

Sensitized Material 3 was prepared in the same manner as preparation of foregoing Sensitized Material 2, except that 0.5 g/m² of zinc oxide (at a particle size of 50 nm) was added to the protective layer.

Preparation of Sensitized Materials 4-9

Sensitized Materials 4-9 were prepared in the same manner as preparation of foregoing Sensitized Material 2, except that Compound (4) was replaced with equimolal amounts Compounds (6)-(11).

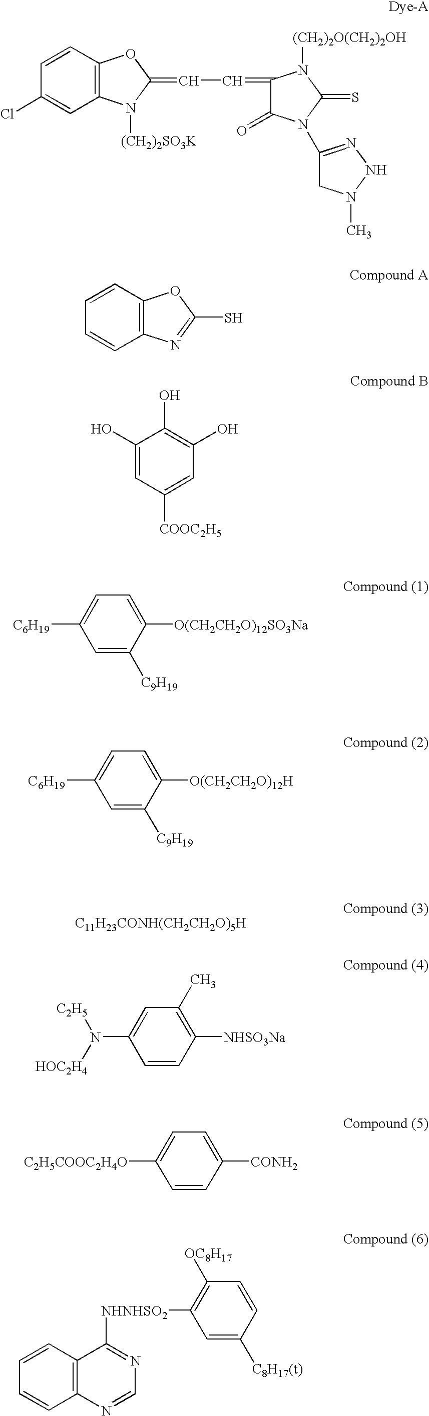

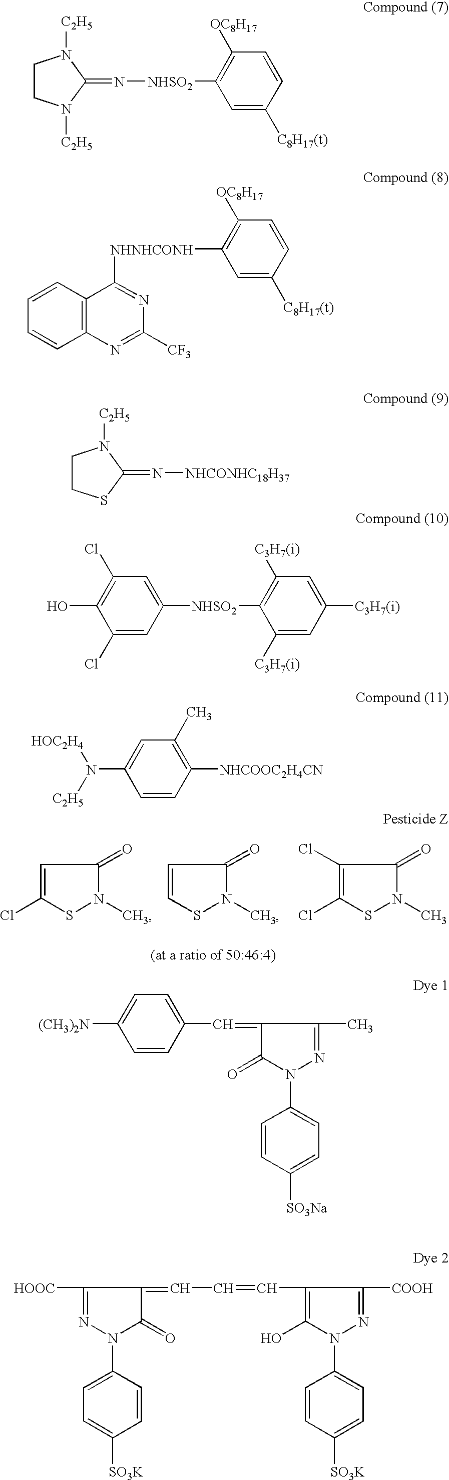

Preparation and Evaluation of Holograms

Processing

Each of the sensitized materials prepared as above was subjected to the following combinations of processing as described in Table 2.

Processing 1

Processing Conditions

| | | Processing |
|---|---|---|
| Process | Processing time | Temperature |
| Development | 30° C. | 60 seconds |
| Washing | ambient temperature | 30 seconds |
| Bleaching | 38° C. | 45 seconds |
| Washing | ambient temperature | 30 seconds |
| Stabilizing | ambient temperature | 30 seconds |
| Drying | 50° C. | 15 seconds |

Composition of Developing Solution

| | | |
|---|---|---|
| L-ascorbic acid | 15 | g |
| Sodium carbonate | 20 | g |
| Sodium hydroxide | 6 | g |
| Sodium bromide | 0.8 | g |
| Phenidone | 0.3 | g |
| Water to make | 1 | liter |
| Composition of Bleaching Solution | | |
| HOOCH₂C—N(CH₂CONH₂)₂ | 0.3 | mol |
| Ethylenediaminetetraacetic acid | 0.03 | mol |
| KBr | 1.3 | mol |
| Glacial acetic acid | 50 | ml |

Adjusted the pH to 4.5 using ammonia water or acetic acid, and brought to 1 liter with water.

Composition of Stabilizing Solution

In water, 2.5 g of potassium iodide was dissolved, and brought to one liter to prepare Stabilizing Solution.

Processing 2

Processing 2 was conducted in the same manner as Processing 1, except that in the compositions of the developing solution described in foregoing Processing 1, L-ascorbic acid, sodium carbonate, sodium hydroxide and phenidone were replaced with 8 g of picolinic acid after which the pH was adjusted to 7.0.

Processing 3

Processing 3 was conducted in the same manner as Processing 1, except that the development process was replaced by a heating development process at 120° C. over 15 seconds.

Preparation of Holograms

Images of cross-sectional image information (continuous image information at equally-spaced pitches) of the lower half of a human head via X-ray tomography were recorded in advance on a computer hard disk as digital signals. From this image information, tomograms comprising 4, 10, 25, 50 and 100 cross-sectional photos respectively were prepared. These tomograms were selected for their equally spaced pitches between images respectively, and printed sequentially in every cross-section on the hologram. With this method, master hologram exposure based on the method of cross-sectional multi recording holograms was applied to the sensitized materials prepared as above. The light source was a light flux of a 488 nm wavelength transmitted from a single Ar laser light source. These methods were conducted based on Eizo Joho (M) [Image Information (M)], 3/1983. Processing was conducted in a combination of the obtained exposed sensitized materials and the processing described in Table 2, and thereby each hologram sample was prepared.

Evaluation of Holograms

To the obtained hologram samples, constant intensity light from an iodine quartz lamp was radiated from a reference light radiation direction. Thus, evaluated were the focused 3-dimensional images of the hologram samples immediately after processing.

Evaluation was conducted as follows. A PR-650 spectral luminance meter, manufactured by Photo Research, Inc. was placed 3,000 mm from the hologram samples, and the spectral radiance (cd/m²) was measured to determine Luminance Value 1. Further, after forced aging processing of the hologram samples at 55° C. and 60% RH for 10 days in a hydrothermostatically controlled chamber, Luminance Value 2 was determined with the similar method. Assuming Luminance Value 1 before forced aging processing as 100%, a luminance ratio after forced aging processing (Luminance Value 2/Luminance Value 1×100%) was determined, the thus obtained luminance ratios are shown in Table 2.

As the luminance ratio approaches 100%, the luminance change of before and after forced aging processing decreases, and a smaller change means image stability of that sample is superior.

TABLE 2

| Hol- | Sen- | AgX | | | | |
|---|---|---|---|---|---|---|
| ogram | sitized | Paricle | Proc- | Development | Lumi- | |
| Sample | Material | Diameter | essing | Temperature | nance | Re- |
| No. | No. | (nm) | No. | (° C.) | (%) | marks |
| 1 | 1 | 110 | 1 | 30 | 64 | Comp. |
| 2 | 2 | 35 | 1 | 30 | 62 | Comp. |
| 4 | 4 | 35 | 3 | 120 | 78 | Inv. |
| 5 | 5 | 35 | 3 | 120 | 91 | Inv. |
| 6 | 6 | 35 | 3 | 120 | 81 | Inv. |
| 7 | 7 | 35 | 3 | 120 | 93 | Inv. |
| 8 | 8 | 35 | 3 | 120 | 85 | Inv. |
| 9 | 9 | 35 | 3 | 120 | 87 | Inv. |

Comp.; Comparative Sample
Inv.; The present invention

As is apparent from Table 2, it was proved that the hologram samples prepared with the hologram forming method of the present invention possessed superior luminance after storage under high temperature and high humidity compared to the comparative samples, and in addition the holograms were superior in image stability.

### Example 2

Preparation of Sensitized Material 10

Sensitized Material 10 was prepared in the same manner as preparation of Sensitized Material 6 described in Example 1, except that 2.0 g/m² of zinc oxide was added to the protective layer.

Processing of the Sensitized Material

Using Sensitized Material 2 and 6 prepared in Example 1 and Sensitized Material 10 as prepared above, processing was conducted under combinations of the sensitized materials and the following processing described in Table 3.

Processing 4

After heating development at 120° C. over 15 sec., each of the sensitized materials was superimposed with following Processing Member 1 applied at 10 g/m² of water, at 43° C. over 40 sec., and then the sensitized material was peeled off.

Processing Member 1

Onto one surface of a 175 μm biaxially-stretched polyrethyleneterephthalate substrate, an additive layer coating composition (being a lower layer) and a protective layer coating composition (being an upper layer) were multi-layer coated. Further, onto the opposite surface of the substrate, a gelatin backing layer at coverage of.1.6 g/m², and a gelatin backing protective layer at coverage of 0.8 g/m² on the protective layer were simultaneous multi-layer coated, and the coated layers were hardened using 4% formalin solution to prepare Processing Member 1.

Additive Agent Layer Coating Composition

| | | |
|---|---|---|
| Gelatin | 15.0 | g/m² |
| 4% formalin solution | 0.14 | ml/g of gelatin |
| 1,3-diaminopropanetetraacetic | 6.5 | g/m² |
| acid ferric ammonium | | |
| Sodium thiosulfate | 8.3 | g/m² |
| Protective Layer Coating | | |
| Composition | | |
| Gelatin | 1.0 | g/m² |
| 4% formalin solution | 0.14 | ml/g of gelatin |

Processing 5 was conducted in the same manner as Processing 4 above, except that Processing Member 2 was used, which was prepared in the same manner except for eliminating sodium thiosulfate from the additive agent layer of Processing Member 1.

Processing 6

Processing 6 was conducted in the same manner as Processing 4 above, except that Processing Member 3 was used, which was prepared in the same manner except for eliminating 1,3-diaminopropanetetraacetic acid ferric ammonium from the additive agent layer of Processing Member 1.

Processing 7

After each of the sensitized materials was superimposed with following Processing Member 4 applied at 10 g/m² of water, heating development was conducted at 85° C. for 30 sec., after which the sensitized material was peeled away.

Processing Member 4

Processing Member 4 was prepared in the same manner as preparation of Processing Member 1, except that 1,3-diaminopropanetetraacetic acid ferric ammonium and sodium thiosulfate were replaced by 0.5 g/m² of hydantoin and 5.0 g/m² of sodium picolinate in the additive agent layer, and 3 mg/m² of PdS was added to the protective layer.

Processing 8

Processing 8 was conducted in the same manner as foregoing Processing 1 except that L-ascorbic acid and phenidon were eliminated from the developing solution and the pH was adjusted to 11.0.

Processing 9

Sensitized Material 10 was superimposed with foregoing Processing Member 4 applied at 10 g/m² of water, and heating development was conducted at 85° C. over 30 sec., after which the sensitized material was peeled away.

Evaluation of Holograms

Holograms were prepared in the same manner as described in Example 1, and image stability (being luminance ratio %) was determined with a method similar to that of Example 1. The obtained results are shown in Table 3.

TABLE 3

| Hol- | Sen- | AgX | | | | |
|---|---|---|---|---|---|---|
| ogram | sitized | Paricle | Proc- | Development | Lumi- | |
| Sample | Material | Diame- | essing | TempeRature | nance | Re- |
| No. | No. | ter (nm) | No. | (° C.) | (%) | marks |
| 2 | 2 | 35 | 1 | 30 | 62 | Comp. |
| 10 | 2 | 35 | 4 | 120 | 77 | Inv. |
| 11 | 2 | 35 | 5 | 120 | 83 | Inv. |
| 12 | 2 | 35 | 6 | 120 | 75 | Inv. |
| 13 | 2 | 35 | 7 | 85 | 84 | Inv. |
| 14 | 2 | 35 | 8 | 30 | 82 | Comp. |
| 15 | 6 | 35 | 4 | 120 | 95 | Inv. |
| 16 | 10 | 35 | 9 | 85 | 98 | Inv. |
| 17 | 1 | 110 | 4 | 120 | 70 | Comp. |

Comp.: Comparative Sample
Inv.: The present invention

As is apparent from Table 3, it was proved that the hologram samples prepared with the hologram forming method of the present invention possessed superior luminance after storage under high temperature and high humidity compared to the comparative samples, and in addition the holograms were superior in image stability.

### Example 3

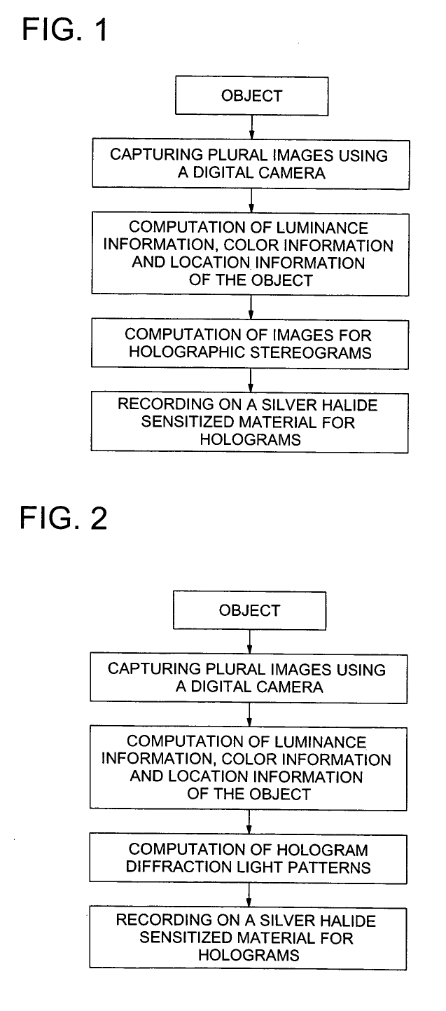

Taking pictures of an object from two directions using a digital steel camera, obtained were image data with stereo views. After every picture element of these data was separated into color information and luminance information, location information of the object was determined utilizing the principle of triangular survey. Based on the color information, luminance information and location information, exposure data to silver halide photographic sensitized material for holograms were prepared by computation of images for holographic stereograms and diffraction patterns of hologram light according to the processing flows shown in FIGS. 1 and 2. Based on the exposure data, using a hologram exposure system described in Example 1, hologram images were prepared conducting Processing 1 to Sensitized Material 1 prepared in Example 1. Thus, it was confirmed that the superior hologram images could be obtained.

According to the present invention, it is possible to provide a silver halide photographic material for hologram recording which exhibits simplicity and convenience, and superiority in environmental adequacy at hologram forming and image stability of recorded hologram images, and to provide a hologram forming method and a hologram forming system with which consumers can enjoy picture taking and viewing easily with a light heart.

What is claimed is:

1. A method for producing a holographic stereogram, comprising the steps of:
(i) computing image information data for producing the holographic stereogram based on a plurality of image data provided by a digital camera;
(ii) recording the image information data on a silver halide photographic material,
(iii) developing the recorded silver halide photographic material at a temperature of between 43 and 180° C.; and
(iv) superimposing the developed silver halide photographic material with a processing member in the presence of an aqueous solvent; and
(v) separating the processing member superimposed on a surface of the developed silver halide photographic material to obtain the holographic stereogram, wherein the silver halide photographic material comprises a support having thereon:
(a) a hydrophilic colloid layer; and
(b) a silver halide emulsion layer containing silver halide grains having an average particle diameter of 5 to 50 nm.

2. The method for producing the holographic stereogram of claim 1,
wherein the hydrophilic colloid layer of the silver halide photographic material further contains an insoluble metal oxide or an insoluble metal hydroxide.

3. The method for producing the holographic stereogram of claim 1,
wherein the silver halide emulsion layer of the silver halide photographic material further contains a compound represented by one of Formulas (1) to (6): 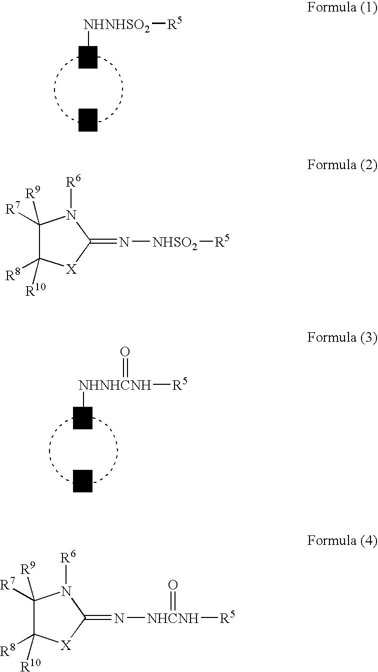
wherein R⁵ is a substituted or unsubstituted alkyl, aryl or heterocyclic group; Z indicates a group of atoms forming an aromatic ring, provided that when Z forms a benzene ring with a carbon atom, the benzene ring have one or a plurality of substituents having a sum of Hammett's constant σp of the substituents is more than 1; R⁶ is a substituted or unsubstituted alkyl group; X is an oxygen atom, a sulfur atom, a selenium atom or a tertiary amino group having an alkyl or aryl group; and R⁷-R¹⁰ each are a hydrogen atom or a substituent, and R⁷-R¹⁰ each may combine with each other to form a double bond or a ring: 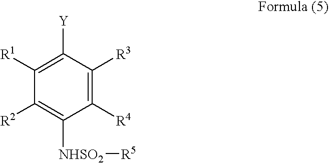
wherein Y is a hydroxyl group or a substituted or unsubstituted amino group; R¹-R⁴ each are a hydrogen atom, a halogen atom, an alkyl group, an aryl group, an alkylcarbonamide group, an arylcarbonamide group, an alkylsulfonamide group, an arylsulfonamide group, an alkoxyl group, an aryloxy group, an alkylthio group, an arylthio group, an alkylcarbamoyl group, an arylcarbamoyl group, a carbamoyl group, an alkylsulfamoyl group, an arylsulfamoyl group, a sulfamoyl group, a cyano group, an alkylsulfonyl group, an arylsulfonyl group, an alkoxycarbonyl group, an aryloxycarbonyl group, an alkylcarbonyl group, an arylcarbonyl group, or an acyoxy group; and R⁵ is the same as R⁵ in Formulas (1)-(4): 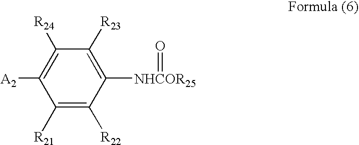
wherein R₂₁-R₂₅ each are a hydrogen atom or a substituent; A₂ is a hydroxyl group or a substituted amino group; R₂₁ and R₂₂, and R₂₃ and R₂₄, may combine with each other to form a ring; and the substituted amino group of A₂ and R₂₁ or R₂₄ may combine with each other to form a ring.

4. The method for producing the holographic stereogram of claim 1,
wherein the processing member containing a silver bleaching agent and a silver halide fixing agent; and an amount of the aqueous solvent used in the step (iv) is between 1/10 and 1/100 of a volume required to maximally swell the silver halide emulsion layer and the hydrophilic colloid layer on the support.

5. The method for producing the holographic stereogram of claim 1,
wherein the processing member containing a silver bleaching agent; and an amount of the aqueous solvent used in the step (iv) is between 1/10 and 1/100 of a volume required to maximally swell the silver halide emulsion layer and the hydrophilic colloid layer on the support.

6. The method for producing a holographic stereogram of claim 1,
wherein the processing member containing a silver halide fixing agent; and an amount of the aqueous solvent used in the step (iv) is between 1/10 and 1/100 of a volume required to maximally swell the silver halide emulsion layer and the hydrophilic colloid layer on the support.

7. The method for producing the holographic stereogram of claim 1,
wherein the hydrophilic colloid layer of the silver halide photographic material further contains an insoluble metal oxide or an insoluble metal hydroxide; the processing member contains a physical developing nucleus, a complex forming agent and a silver fixing agent; and an amount of the aqueous solvent used in the step (iv) is between 1/10 and 1/100 of a volume required to maximally swell the silver halide emulsion layer and the hydrophilic colloid layer on the support.

8. The method for producing the holographic stereogram of claim 1, further comprising the step of:
subjecting the exposed silver halide photographic material to an activator processing prior to the step (iii).
